(19) United States
(12) Patent Application Publication
(10) Pub. No.: US 2015/0012496 A1
(43) Pub. Date: Jan. 8, 2015

(54) STORAGE DEVICE AND METHOD FOR CONTROLLING STORAGE DEVICE

(71) Applicant: FUJITSU LIMITED, Kawasaki-shi (JP)

(72) Inventor: Kiyoto MINAMIURA, Koto (JP)

(73) Assignee: FUJITSU LIMITED, Kawasaki-shi (JP)

(21) Appl. No.: 14/279,777

(22) Filed: May 16, 2014

(30) Foreign Application Priority Data
Jul. 4, 2013 (JP) 2013-140838

(51) Int. Cl. G06F 11/14

(52) U.S. Cl. CPC G06F 11/1458
USPC 707/654

(57) ABSTRACT

A storage device includes a first storage unit, a second storage unit, and a processor. The first storage unit is configured to temporarily store therein a file. The second storage unit is configured to store therein backup data of the file stored in the first storage unit. The processor is configured to manage update states of files stored in the first storage unit and a requirement to be satisfied for backing up the files stored in the first storage unit into the second storage unit. The processor is configured to store, in the second storage unit, first backup data of a first file among the files stored in the first storage unit. An update state of the first file satisfies the requirement.

### CROSS-REFERENCE TO RELATED APPLICATION

This application is based upon and claims the benefit of priority of the prior Japanese Patent Application No. 2013-140838, filed on Jul. 4, 2013, the entire contents of which are incorporated herein by reference.

### FIELD

The embodiments discussed herein are related to a storage device and a method for controlling a storage device.

### BACKGROUND

When data processing is performed by a plurality of information processing devices, a file server (storage device) may centrally manage data in order to efficiently maintain and manage the data. The file server is a network attached storage (NAS) device, for example.

With increases in capacities and processing performance of NAS devices in recent years, data is backed up by the NAS devices in order to protect the data in cloud environments in which many users use a wide variety of application processes in general.

The backup of data by an NAS device is determined based on an average amount of data to be updated in an overall system and an average frequency of the updating, and is performed at regular intervals on a monthly, daily, or hourly basis or the like in accordance with an operation of an operator or settings.

Related techniques are disclosed in, for example, Japanese Laid-open Patent Publication No. 9-212424 and Japanese Laid-open Patent Publication No. 2005-301419.

However, if the backup of the data is set so as to be performed at intervals of one hour, data used by an application process that updates data on a minute basis is updated over several generations within each of the backup intervals. The backup of data of several generations within each of the backup intervals is skipped. Thus, when data of a previous generation or data before 10 minutes is required to be restored, the data to be restored does not exist.

If the backup intervals are set to short intervals (of, for example, 5 minutes), it is possible to inhibit loss of data to be restored.

As described above, however, under an environment in which many users use a variety of application processes, frequencies of updating data to be used vary and it is not easy to set appropriate backup intervals. For example, although a risk that data to be restored does not exist may be reduced by setting backup intervals to be short, the frequency of the backup of data that is not updated is high and a storage region for storing the backup data is very large. In addition, the backup data of many generations is generated and the man-hour of maintaining and managing the backup data increases.

### SUMMARY

According to an aspect of the present invention, provided is a storage device including a first storage unit, a second storage unit, and a processor. The first storage unit is configured to temporarily store therein a file. The second storage unit is configured to store therein backup data of the file stored in the first storage unit. The processor is configured to manage update states of files stored in the first storage unit and a requirement to be satisfied for backing up the files stored in the first storage unit into the second storage unit. The processor is configured to store, in the second storage unit, first backup data of a first file among the files stored in the first storage unit. An update state of the first file satisfies the requirement.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a storage device according to a first embodiment;

FIG. 2 is a diagram illustrating an example of a configuration of a storage system according to a second embodiment;

FIG. 3 is a diagram illustrating an example of a hardware configuration of an NAS device according to the second embodiment;

FIG. 4 is a flowchart of a regular backup process according to the second embodiment;

FIG. 5 is a diagram illustrating an example of regular backup according to the second embodiment;

FIG. 6 is a flowchart of a process of updating cached data according to the second embodiment;

FIG. 7 is a flowchart of a process of generating a management table according to the second embodiment;

FIG. 8 is a diagram illustrating an example of a management table according to the second embodiment;

FIG. 9 is a flowchart of an irregular backup process according to the second embodiment; and

FIG. 10 is a diagram illustrating an example of regular backup and irregular backup according to the second embodiment.

### DESCRIPTION OF EMBODIMENTS

Hereinafter, embodiments are described in detail with reference to the accompanying drawings.

### First Embodiment

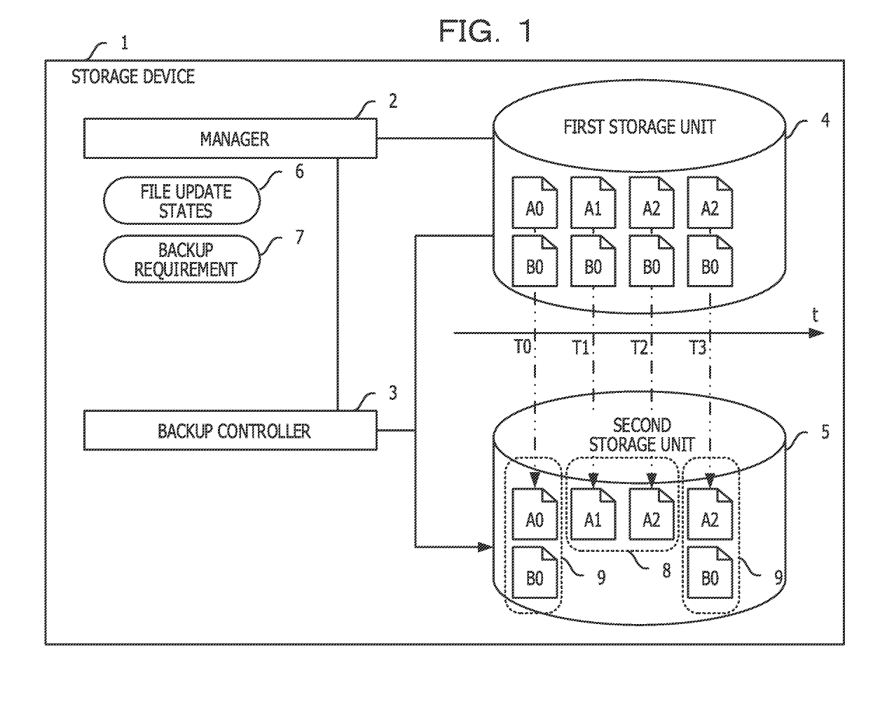

First, a storage device according to a first embodiment is described with reference to FIG. 1. FIG. 1 is a diagram illustrating an example of a configuration of a storage device according to the first embodiment.

A storage device 1 stores and maintains data on a file basis and regularly or irregularly backs up files stored and maintained. The storage device 1 includes a manager 2, a backup controller 3, a first storage unit 4, and a second storage unit 5.

The first storage unit 4 is configured to temporarily store files written. The first storage unit 4 functions as a write cache. It is preferable that the first storage unit 4 have access speed performance higher than access speed performance of the second storage unit 5.

The second storage unit 5 is configured to store backup data of the files stored in the first storage unit 4. The second storage unit 5 functions as a backup disk. It is preferable that the second storage unit 5 have a storage region with a capacity larger than a capacity of a storage region of the first storage unit 4.

The manager 2 manages file update states 6 and a backup requirement 7. Each of the file update states 6 is information including an update state of a file stored in the first storage unit 4. The backup requirement 7 is information including a requirement to be satisfied for backing up a file stored in the first storage unit 4 into the second storage unit 5.

The backup controller 3 causes a file that is stored in the first storage unit 4 and the file update state 6 thereof satisfies the backup requirement 7 to be stored as first backup data 8 in the second storage unit 5.

Thus, the storage device 1 may back up data that is frequently updated without excessively increasing the number of processes of managing backup data.

The update and backup of the file along a timeline t (from a time T0 to a time T3) are described below. One-dot chain lines illustrated in FIG. 1 represent first backup (irregular backup) performed when a file update state 6 of a file satisfies the backup requirement 7. Two-dot chain lines illustrated in FIG. 1 represent second backup (regular backup) that is regularly performed. The backup controller 3 causes the files stored in the first storage unit 4 to be regularly stored as second backup data 9 in the second storage unit 5.

At the time T0, the first storage unit 4 has files A0 and B0 stored therein. The storage device 1 backs up the file A0 and the file B0 into the second storage unit 5 at the time T0 that is a time at which the regular backup is performed regardless of whether or not the backup requirement 7 is satisfied.

When the file A0 is updated to a file A1 and the file update state 6 of the file A1 satisfies the backup requirement 7 at a time T1, the storage device 1 backs up the file A1 into the second storage unit 5. Similarly, when the file A1 is updated to a file A2 and the file update state 6 of the file A2 satisfies the backup requirement 7 at a time T2, the storage device 1 backs up the file A2 into the second storage unit 5. The file update state 6 is updated when a file stored in the first storage unit 4 is updated.

At the time T3 that is a time at which the regular backup is performed, the first storage unit 4 has the files A2 and B0 stored therein. The storage device 1 backs up the file A2 and the file B0 into the second storage unit 5 at the time T3.

As a result, the second storage unit 5 stores the files A0 and B0 at the time T0, stores the file A1 at the time T1, stores the file A2 at the time T2, and stores the files A2 and B0 at the time T3. Thus, the storage device 1 may back up an updated file (for example, file A1) that is generated within an interval between times of the regular backup. The storage device 1 redundantly backs up the file B0 at the times T0 and T3 of the regular backup. The storage device 1, however, may back up an updated file without setting an interval between times of the regular backup to a short interval and may therefore suppress redundant backup.

If the first storage unit 4 has access speed performance higher than access speed performance of the second storage unit 5, the first storage unit 4 may be a solid state drive (SSD) such as a flash memory drive and the second storage unit 5 may be a hard disk drive (HDD), for example. Alternatively, the first storage unit 4 may be an online disk and the second storage unit 5 may be a near-line disk, for example. In this case, the first storage unit 4 and the second storage unit 5 may be HDDs that are different in performance from each other, or the first storage unit 4 and the second storage unit 5 may be SSDs that are different in performance from each other.

### Second Embodiment

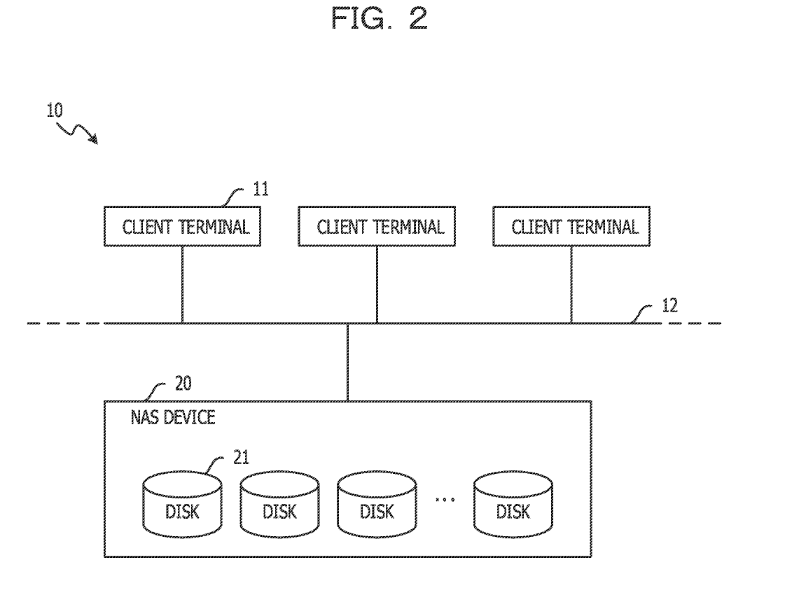

A storage system according to a second embodiment is described with reference to FIG. 2. FIG. 2 is a diagram illustrating an example of a configuration of a storage system according to the second embodiment.

A storage system 10 includes a plurality of client terminals (information processing terminals) 11, an NAS device 20, and a local area network (LAN) 12. The client terminals 11 use a file connection function provided by the NAS device 20 to process data for each user or for each application process. The NAS device 20 is a file server that provides the file connection function to the client terminals 11. The NAS device 20 has a plurality of disks (storage devices) 21 and has storage regions of a large capacity. The LAN 12 is a communication path that is a wireless path or a cable or includes a wireless path and a cable. The LAN 12 connects the client terminals 11 to the NAS device 20. The LAN 12 is an example of a network that connects the client terminals 11 to the NAS device 20. The LAN 12 may include a public line and the like.

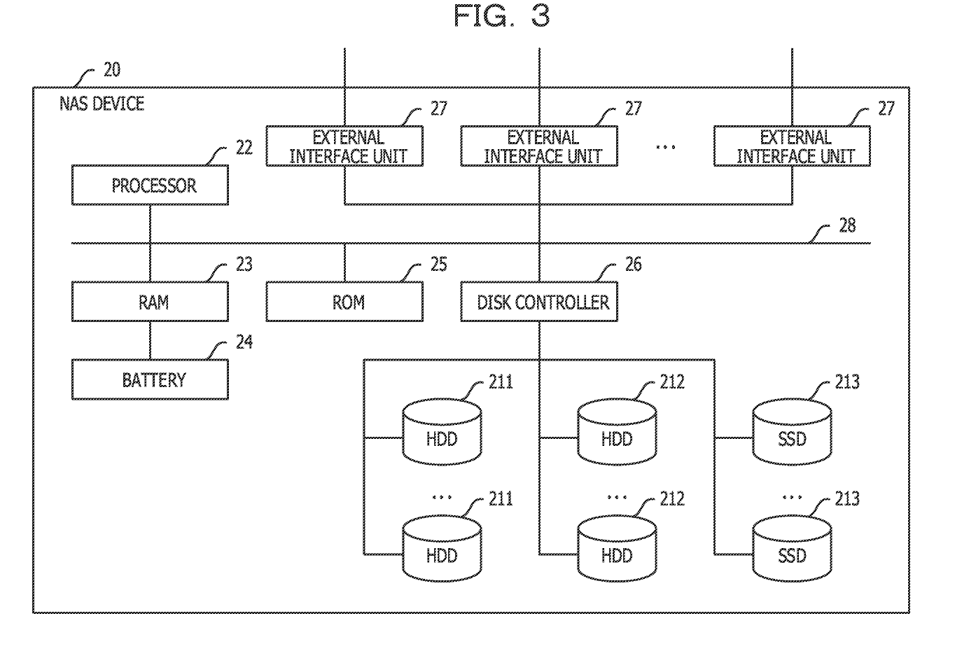

Next, the NAS device 20 according to the second embodiment is described with reference to FIG. 3. FIG. 3 is a diagram illustrating an example of a hardware configuration of the NAS device according to the second embodiment.

The overall NAS device 20 is controlled by a processor 22. The processor 22 is connected to a random access memory (RAM) 23 and a plurality of peripheral devices through a bus 28.

The processor 22 may be a multiprocessor. The processor 22 is, for example, a central processing unit (CPU), a micro processing unit (MPU), a digital signal processor (DSP), an application specific integrated circuit (ASIC), or a programmable logic device (PLD). The processor 22 may be a combination of two or more of a CPU, an MPU, a DSP, an ASIC, and a PLD.

The RAM 23 is used as a main storage device for the NAS device 20. The RAM 23 temporarily stores therein at least a part of an operating system (OS) program, firmware, and an application program to be executed by the processor 22. In addition, the RAM 23 stores therein various types of data to be used for processes to be performed by the processor 22. Furthermore, the RAM 23 temporarily stores therein data that is transferred between the client terminals 11 and the NAS device 20. The RAM 23 may include a memory for storing data of various types and a cache memory separated from the memory. Power supply to the RAM 23 is backed up by a battery 24. The battery 24 is a lithium ion battery or the like, for example.

The peripheral devices connected to the bus 28 are a read only memory (ROM) 25, a disk controller 26, external interface units 27, and the like.

The ROM 25 holds stored data even if a power source of the NAS device 20 is shut down. The ROM 25 is a semiconductor storage device such as an electrically erasable and programmable ROM (EEPROM) or a flash memory, an HDD, or the like, for example. The ROM 25 is used as an auxiliary storage device for the NAS device 20. The ROM 25 stores therein the OS program, the firmware, the application program, and data of various types. The ROM 25 stores a procedure (backup program) for backing up data and a procedure (restoration program) for restoring data.

The disk controller 26 controls disks (HDDs 211, HDDs 212, and SSDs 213) for storing files. The disks (HDDs 211, HDDs 212, and SSDs 213) may be included in the NAS device 20 or arranged outside the NAS device 20 and connected to the NAS device 20. The disk controller 26 controls data transfer between the disks and the bus 28.

The external interface units 27 control interfaces (for example, Ethernet (registered trademark)) connected to the LAN 12. The plurality of external interface units 27 are provided in order to have redundancy or distribute a load.

The HDDs 211 are storage devices for storing therein data that is used to provide the file connection function to the client terminals 11. For example, a plurality of HDDs 211 are provided and may therefore form a redundant array of inexpensive disks (RAID). The HDDs 212 are storage devices for storing therein backup data of the HDDs 211 and SSDs 213.

The SSDs 213 are storage devices for temporarily storing therein data before the data is written in the HDDs 211 and function as write caches. When data is to be written in the HDDs 211 from the client terminals 11, the SSDs 213 are used as the write caches before the data is written in the HDDs 211.

For example, when the disk controller 26 receives a request to write data in an HDD 211 from a client terminal 11 and an SSD 213 has an available region, the disk controller 26 temporarily writes the data in the SSD 213. After that, the disk controller 26 writes the data in the HDD 211. The disk controller 26 uses a timer (for example, an increment timer) to monitor a time period during which the data written in the SSD 213 is held by the SSD 213. The disk controller 26 resets the timer when the same data is to be written within a predetermined time period, that is, the data is to be updated. If the same data is not written within the predetermined time period, that is, a time set in the timer expires, the disk controller 26 writes the data stored in the SSD 213 into an HDD 211 and releases the region of the SSD 213. Thus, among pieces of data that are temporarily stored in the SSDs 213, a piece of data to be frequently updated is held by the SSDs 213 for longer time periods than a piece of data not to be updated.

In the aforementioned manner, the disk controller 26 uses the SSDs 213 as the write caches and thereby enables the NAS device 20 to write data at a high rate.

The aforementioned configuration may achieve processing functions of the NAS device 20 according to the second embodiment. The storage device 1 described in the first embodiment may be achieved by the same hardware configuration as the hardware configuration of the NAS device 20 (illustrated in FIG. 3) provided with the processor 22 and the disk controller 26.

The NAS device 20 achieves the processing functions according to the second embodiment by executing a program stored in a computer-readable recording medium. The program that describes the processes performed by the NAS device 20 may be stored in various recording media. For example, a program to be executed by the NAS device 20 may be stored in the ROM 25. The processor 22 loads at least a part of the program stored in the ROM 25 into the RAM 23 and executes the program. In addition, the program to be executed by the NAS device 20 may be stored in a portable recording medium such as an optical disc (not illustrated), a memory device (not illustrated), or a memory card (not illustrated). The optical disc may be a digital versatile disc (DVD), a DVD-RAM, a compact disc read only memory (CD-ROM), a CD-readable (CD-R), a CD-rewritable (CD-RW), or the like. The memory device is a recording medium that has a function of communicating with the external interface units 27 or a device connection interface (not illustrated). For example, the memory device may use a memory reader/writer to write data in a memory card or read data from the memory card. The memory card is a card type recording medium.

The program stored in the portable recording medium is installed in the RAM 23 under control of the processor 22 and executed. The processor 22 may read the program directly from the portable recording medium and execute the program.

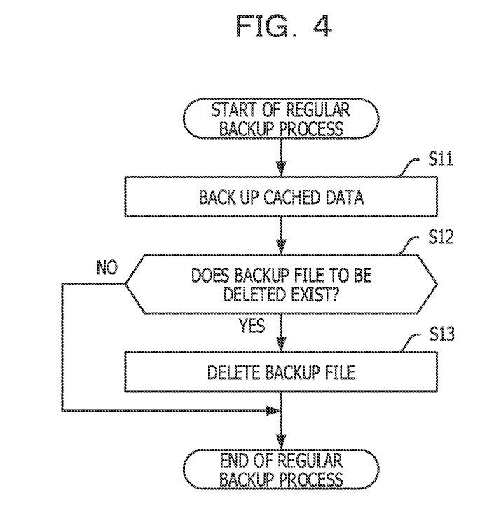

Next, a regular backup process according to the second embodiment is described with reference to FIG. 4. FIG. 4 is a flowchart of the regular backup process according to the second embodiment.

The regular backup process is a process of backing up data stored in the SSDs 213 into the HDDs 212 at regular intervals. The regular backup process is performed by the processor 22 at predetermined times (for example, times set in advance).

In S11, the processor 22 backs up data cached in the SSDs 213 into the HDDs 212.

In S12, the processor 22 determines whether or not a backup file to be deleted exists. If a backup file to be deleted exists, the processor 22 causes the regular backup process to proceed to S13. If no backup file to be deleted exists, the processor 22 terminates the regular backup process. The processor 22 determines, based on a preset definition file, whether or not a backup file to be deleted exists. The definition file stores requirements to be satisfied for holding or deleting a backup file. The requirements are relevant to, for example, updating by rewriting, updating by addition, the number of generations of backup data to be held, and the like.

In S13, the processor 22 deletes the backup file to be deleted. After S13, the processor 22 terminates the regular backup process.

According to the regular backup process, the NAS device 20 may regularly back up data cached in the SSDs 213 into the HDDs 212. The regular backup process may be performed to back up the data cached in the SSDs 213 and data stored in HDDs 211.

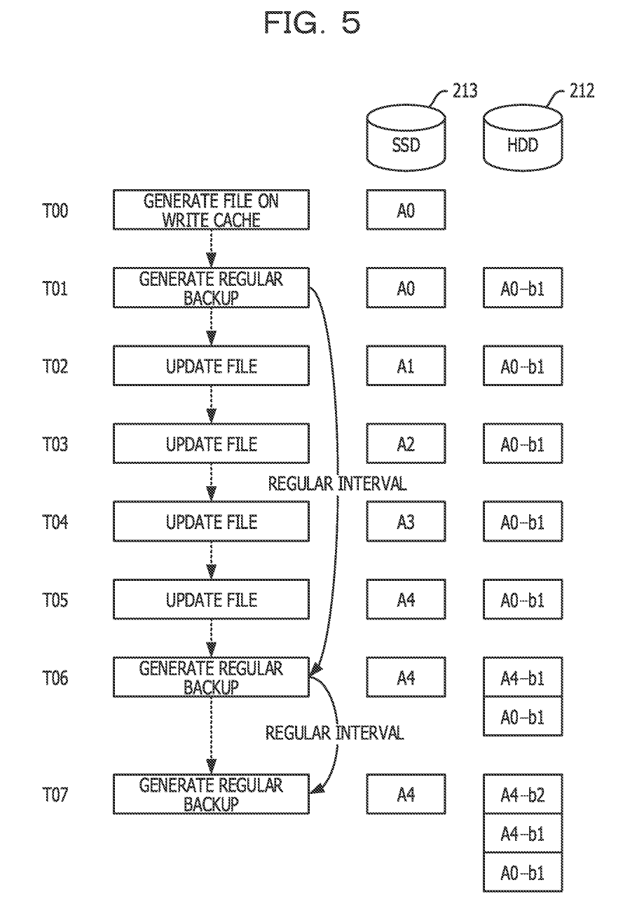

Next, an example of the regular backup process is described with reference to FIG. 5. FIG. 5 is a diagram illustrating an example of regular backup according to the second embodiment. Files in FIG. 5 have different file names A0, A1, A2, A3, and A4 in order to easily distinguish generations from each other, but are files with the same UNIX inode number.

At a time T00, the NAS device 20 generates the file A0 on a write cache. Thus, an SSD 213 stores therein the file A0. An HDD 212 has yet to back up the file A0 at the time T00 since the time T00 is before the regular backup.

At a time T01, the NAS device 20 generates a backup file A0-b1 as a regular backup of the file A0 stored on the write cache. Thus, the HDD 212 stores therein the backup file A0-b1 of the file A0.

At a time T02, the NAS device 20 updates the file A0 stored on the write cache to the file A1. Thus, the SSD 213 stores therein the file A1. The HDD 212 holds the backup file A0-b1, but has yet to back up the file A1 at the time T02 since the time T02 is before the next regular backup.

At a time T03, the NAS device 20 updates the file A1 stored on the write cache to the file A2. Thus, the SSD 213 stores therein the file A2. The HDD 212 holds the file A0-b1, but has yet to back up the file A2 at the time T03 since the time T03 is before the next regular backup.

At a time T04, the NAS device 20 updates the file A2 stored on the write cache to the file A3. Thus, the SSD 213 stores therein the file A3. The HDD 212 holds the file A0-b1, but has yet to back up the file A3 at the time T04 since the time T04 is before the next regular backup.

At a time T05, the NAS device 20 updates the file A3 stored on the write cache to the file A4. Thus, the SSD 213 stores therein the file A4. The HDD 212 holds the file A0-b1, but has yet to back up the file A4 at the time T05 since the time T05 is before the next regular backup.

At a time T06, the NAS device 20 generates a backup file A4-b1 as a regular backup of the file A4 stored on the write cache. Thus, the HDD 212 stores therein the backup file A4-b1 of the file A4 while having the backup file A0-b1 stored therein.

At a time T07, the NAS device 20 generates a backup file A4-b2 as a regular backup of the file A4 stored on the write cache. Thus, the HDD 212 stores therein the backup file A4-b2 of the file A4 while having stored therein the backup file A0-b1 of the file A0 and the backup file A4-b1 of the file A4. If a backup file to be deleted exists, the NAS device 20 deletes the backup file to be deleted.

As described above, the NAS device 20 does not back up the files (files A1, A2, and A3) of second to fourth generations within a time interval between the times when the regular backup is performed. If the interval between the times when the regular backup is performed is reduced, the NAS device 20 may back up the files of the second to fourth generations, but may redundantly store backup files such as the backup files A4-b1 and A4-b2 in many cases. In addition, in the NAS device 20, the number of generations of backup files increases, and the number of processes of managing files increases.

To avoid this, the NAS device 20 backs up a file to be repeatedly updated, such as the file A (A0, A1, A2, A3, and A4) illustrated in FIG. 5 or a file to be held by a write cache for a long time period. A process of backing up such a file to be updated is described below.

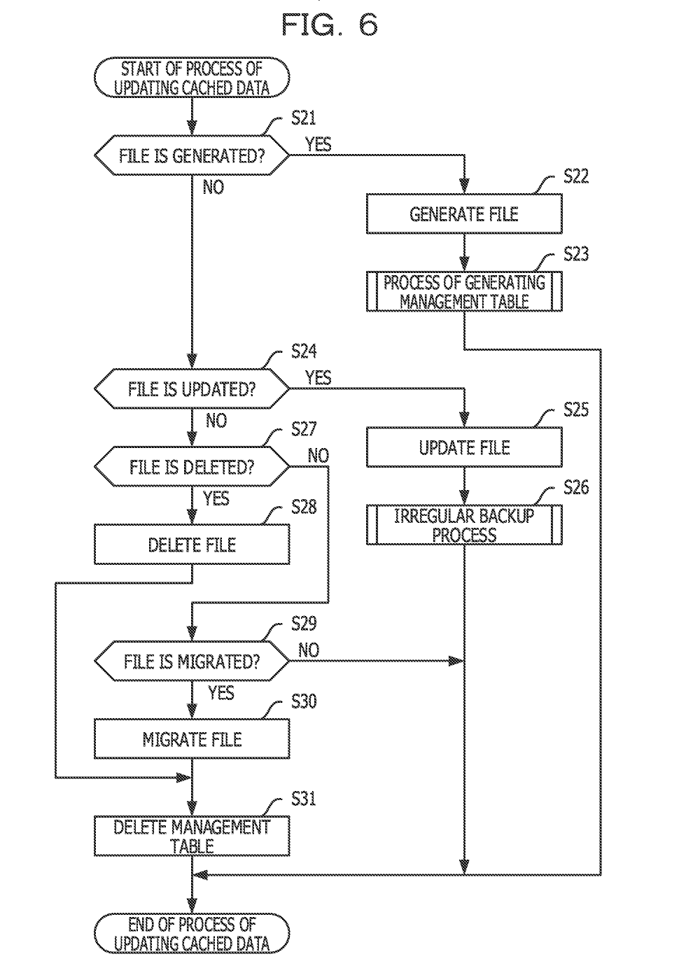

First, a process of updating cached data according to the second embodiment is described with reference to FIG. 6. FIG. 6 is a flowchart of the process of updating cached data according to the second embodiment.

The process of updating cached data is a process of updating data (cached data) stored in the SSDs 213. The process of updating cached data is performed by the processor 22 when data stored in an SSD 213 is to be updated. Times when the process of updating cached data is performed include a time when a file is to be generated, a time when a file is to be updated, a time when a file is to be deleted, a time when a file is to be migrated (or purged from a write cache).

In S21, the processor 22 determines whether to generate a file on a write cache. If the processor 22 generates a file on the write cache, the processor 22 causes the process to proceed to S22. If the processor 22 does not generate a file on the write cache, the processor 22 causes the process to proceed to S24.

In S22, the processor 22 generates the file on the write cache.

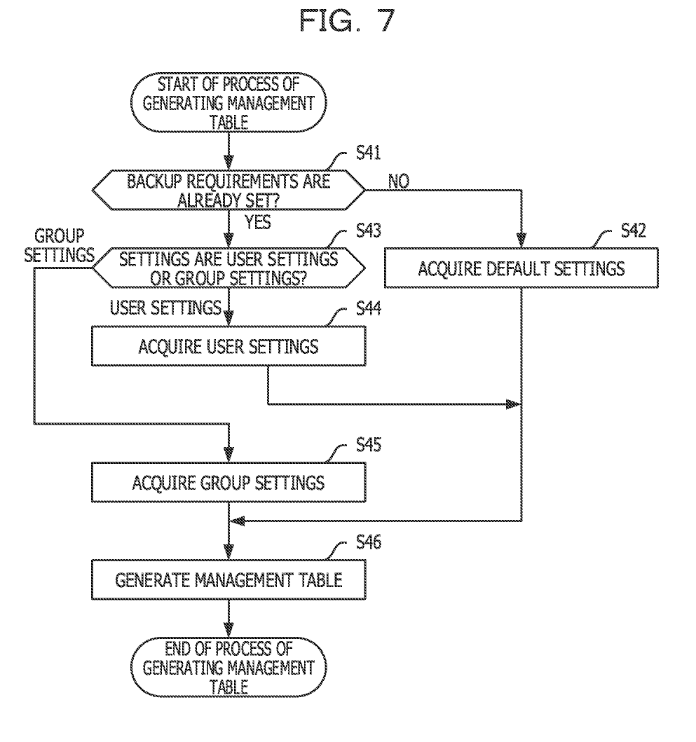

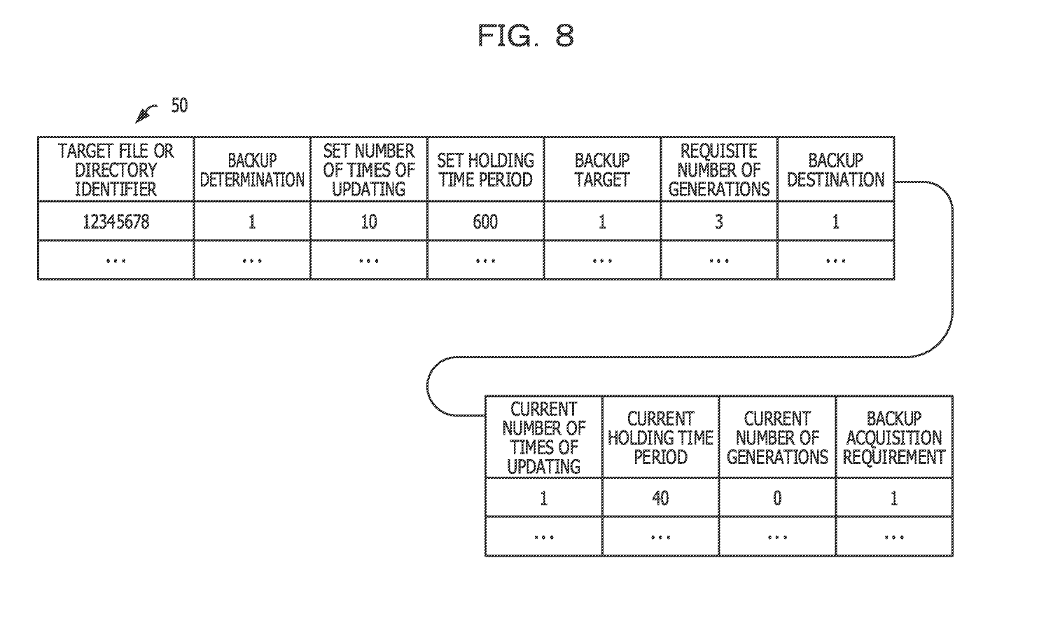

In S23, the processor 22 performs a process of generating a management table. The process of generating a management table is to generate a management table for the file generated on the write cache. The management table and the process of generating a management table are described later with reference to FIGS. 7 and 8. The processor 22 terminates the process of updating cached data after performing the process of generating a management table.

In S24, the processor 22 determines whether to update a file stored on the write cache. If the processor 22 updates a file stored on the write cache, the processor 22 causes the process to proceed to S25. If the processor 22 does not update a file stored on the write cache, the processor 22 causes the process to proceed to S27.

In S25, the processor 22 updates the file stored on the write cache.

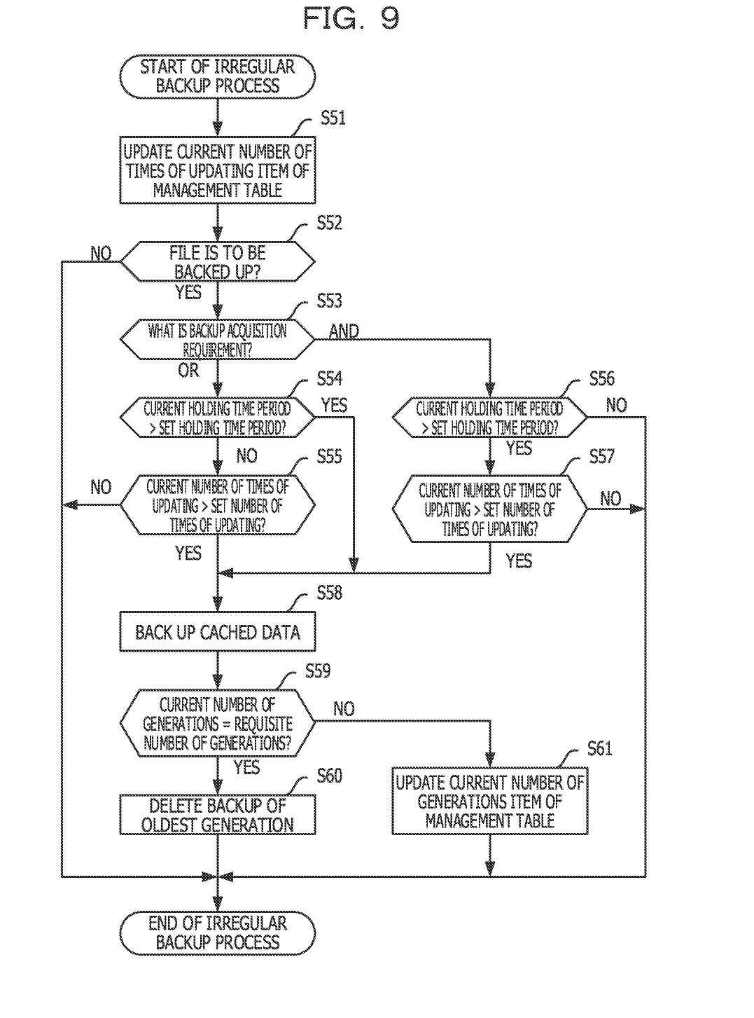

In S26, the processor 22 performs an irregular backup process. The irregular backup process is to back up an updated file stored on a write cache. The irregular backup process is described later with reference to FIG. 9. The processor 22 terminates the process of updating cached data after performing the irregular backup process.

In S27, the processor 22 determines whether to delete a file stored on the write cache. If the processor 22 deletes a file stored on the write cache, the processor 22 causes the process to proceed to S28. If the processor 22 does not delete a file stored on the write cache, the processor 22 causes the process to proceed to S29.

In S28, the processor 22 deletes the file stored on the write cache.

In S29, the processor 22 determines whether to migrate a file stored on the write cache. If the processor 22 migrates a file stored on the write cache, the processor 22 causes the process to proceed to S30. If the processor 22 does not migrate a file stored on the write cache, the processor 22 terminates the process of updating cached data.

In S30, the processor 22 migrates the file stored on the write cache. Specifically, the processor 22 copies the file into an HDD 211 and deletes the file from the SSD 213.

In S31, the processor 22 deletes a management table for the file deleted or migrated from the write cache and terminates the process of updating cached data.

Next, the process of generating a management table according to the second embodiment is described with reference to FIG. 7. FIG. 7 is a flowchart of the process of generating a management table according to the second embodiment.

Before the process of generating a management table is described, the management table is described with reference to FIG. 8. FIG. 8 is a diagram illustrating an example of a management table according to the second embodiment.

A management table 50 stores requirement information items indicating backup requirements set for files or directories and state information items indicating states of the files or directories held by the write caches.

A “target file or directory identifier” item of the management table 50 represents information that uniquely identifies a file or directory that is held by a write cache. The “target file or directory identifier” item stores a UNIX inode number, for example. The processor 22 may identify a file or a directory from a target file or directory identifier “12345678”, for example.

A “backup determination” item of the management table 50 is one of the requirement information items. The “backup determination” item is information (flag) that indicates whether or not a file or directory that is identified by the “target file or directory identifier” item is to be backed up. The “backup determination” item stores “1” or “2”, for example. If the “backup determination” item stores “1”, the file or directory is to be backed up. If the “backup determination” item stores “2”, the file or directory is not to be backed up.

A “set number of times of updating” item of the management table 50 is one of the requirement information items. The “set number of times of updating” item is one of backup requirements for a file or directory that is identified by the “target file or directory identifier” item. The “set number of times of updating” item represents a set number of times of updating of the file or directory. The “set number of times of updating” item stores an integer, for example. If the “set number of times of updating” item stores “1”, the “set number of times of updating” item indicates that the file or directory is backed up for the first updating. If the “set number of times of updating” item stores “10”, the “set number of times of updating” item indicates that the file or directory is backed up for the tenth updating.

A “set holding time period” item of the management table 50 is one of the requirement information items. The “set holding time period” item is one of the backup requirements for a file or directory that is identified by the “target file or directory identifier” item. The “set holding time period” item represents a set period of time to hold the file or directory. The “set holding time period” item stores an integer, for example. If the “set holding time period” item stores “100”, the “set holding time period” item indicates that the file or directory is backed up after staying in the write cache for a time period of 100 seconds. If the “set holding time period” item stores “600”, the “set holding time period” item indicates that the file or directory is backed up after staying in the write cache for a time period of 600 seconds.

A “backup target” item of the management table 50 is one of the requirement information items. The “backup target” item is information (flag) representing whether a file or directory that is identified by the “target file or directory identifier” item is a file or a directory. The “backup target” item stores “1” or “2”, for example. If the “backup target” item stores “1”, the “backup target” item indicates that a target to be backed up is a file. If the “backup target” item stores “2”, the “backup target” item indicates that the target to be backed up is a directory.

A “requisite number of generations” item of the management table 50 is one of the requirement information items. The “requisite number of generations” item is one of the backup requirements for a file or directory that is identified by the “target file or directory identifier” item. The “requisite number of generations” item stores a set requisite number of generations of the file or directory to be held. The “requisite number of generations” item stores an integer, for example. If the “requisite number of generations” item stores “1”, the “requisite number of generations” item indicates that the file or directory of one generation is backed up. If the “requisite number of generations” item stores “3”, the “requisite number of generations” item indicates that the files or directories of three generations is backed up.

A “backup destination” item of the management table 50 is one of the requirement information items. The “backup destination” item is one of the backup requirements for a file or directory that is identified by the “target file or directory identifier” item. The “backup destination” item stores a set value representing a destination into which the file or directory is backed up. The “backup destination” item stores an integer, for example. If the “backup destination” item stores “1”, the “backup destination” item indicates that the file or directory is backed up into an HDD 212. If the “backup destination” item stores “2”, the “backup destination” item indicates that the file or directory is backed up into an SSD that is different from the write cache. The “backup destination” item may represent a storage device that is an externally connected storage device or the like other than the disks illustrated in FIG. 3.

A “current number of times of updating” item of the management table 50 is one of the state information items. The “current number of times of updating” item represents the number of times of updating a file or directory that is identified by the “target file or directory identifier” item. The “current number of times of updating” item stores an integer, for example. If the “current number of times of updating” item stores “1”, the “current number of times of updating” item indicates that the number of times of updating the file or directory is 1. If “current number of times of updating” item stores “2”, the “current number of times of updating” item indicates that the number of times of updating the file or directory is 2.

A “current holding time period” item of the management table 50 is one of the state information items. The “current holding time period” item represents a time period during which a file or directory that is identified by the “target file or directory identifier” item is held by the write cache. The “current holding time period” item stores an integer, for example. If the “current holding time period” item stores “10”, the time period (holding time period) during which the file or directory is held by the write cache is 10 seconds. If the “current holding time period” item stores “40”, the holding time period is 40 seconds.

A “current number of generations” item of the management table 50 is one of the state information items. The “current number of generations” item represents the number of generations of held backups of a file or directory that is identified by the “target file or directory identifier” item. The “current number of generations” item stores an integer, for example. If the “current number of generations” item stores “0”, the “current number of generations” item indicates that no backup of the file or directory is held. If the “current number of generations” item stores “2”, the “current number of generations” item indicates that the number of generations of held backups of the file or directory is 2.

A “backup acquisition requirement” item of the management table 50 is one of the requirement information items. The “backup acquisition requirement” item is one of the backup requirements for a file or directory that is identified by the “target file or directory identifier” item. The “backup acquisition requirement” item represents a conditional expression for starting backing up the file or directory. The “backup acquisition requirement” item stores an integer, for example. If the “backup acquisition requirement” item stores “1”, the “backup acquisition requirement” item represents a logical sum of satisfaction of a requirement for the number of times of updating and satisfaction of a requirement for the holding time period. If the “backup acquisition requirement” item stores “2”, the “backup acquisition requirement” item represents a logical product of the satisfaction of the requirement for the number of times of updating and the satisfaction of the requirement for the holding time period.

The management table 50 is held by the RAM 23, but may be held by another storage device. For example, the management table 50 may be metadata of the files held by the SSDs 213 that function as the write caches. If a part or all of the processes related to the backup is performed by the disk controller 26 instead of the processor 22, the management table 50 may be held in a storage region included in the disk controller 26.

Returning to the description of the process of generating a management table, the process of generating a management table is a process to generate a management table for data stored in the SSDs 213. The processor 22 uses the management table in order to determine the timing of backing up each of files stored in the SSDs 213. The process of generating a management table is performed in S23 of the process of updating cached data.

In S41, the processor 22 determines whether or not the backup requirements are already set for data for which the management table is generated. If the backup requirements are already set for the data for which the management table is generated, the processor 22 causes the process to proceed to S43. If the backup requirements are not set for the data for which the management table is generated, the processor 22 causes the process to proceed to S42.

In S42, the processor 22 acquires default settings.

In S43, the processor 22 determines whether the backup requirements set for the data for which the management table is generated are user settings for each of users or group settings for each of groups to which the users belong. If the backup requirements are user settings, the processor 22 causes the process to proceed to S44. If the backup requirements are group settings, the processor 22 causes the process to proceed to S45.

In S44, the processor 22 acquires the user settings.

In S45, the processor 22 acquires the group settings.

In S46, the processor 22 generates the management table. Specifically, the processor 22 adds one row to the management table and records an identifier (inode) identifying the data for which the management table is generated. Then, the processor 22 copies the acquired settings to the requirement information items and initializes the state information items to generate the management table.

Next, the irregular backup process according to the second embodiment is described with reference to FIG. 9. FIG. 9 is a flowchart of the irregular backup process according to the second embodiment.

The irregular backup process is a process to back up data (cached data) stored in the SSDs 213. The irregular backup process is performed in S26 of the process of updating cached data.

In S51, the processor 22 updates the “current number of times of updating” item of the management table 50 for the updated file. The “current holding time period” item of the management table 50 may be updated by an update process (not illustrated) at each of predetermined time intervals. Alternatively, the “current holding time period” item of the management table 50 may be updated when the “current number of times of updating” item of the management table 50 is updated.

In S52, the processor 22 references the “backup determination” item of the management table 50 and determines whether the updated file is to be backed up. If the updated file is to be backed up, the processor 22 causes the irregular backup process to proceed to S53. If the updated file is not to be backed up, the processor 22 terminates the irregular backup process.

In S53, the processor 22 references the “backup acquisition requirement” item of the management table 50 and determines a backup acquisition requirement. If the backup acquisition requirement is “OR (logical sum)”, the processor 22 causes the irregular backup process to proceed to S54.

If the backup acquisition requirement is “AND (logical product)”, the processor 22 causes the irregular backup process to proceed to S56.

In S54, the processor 22 compares a value of the “current holding time period” item of the management table 50 with a value of the “set holding time period” item of the management table 50. If the value of the “current holding time period” item of the management table 50 is larger than the value of the “set holding time period” item of the management table 50, the processor 22 causes the irregular backup process to proceed to S58. If the value of the “current holding time period” item of the management table 50 is not larger than the value of the “set holding time period” item of the management table 50, the processor 22 causes the irregular backup process to proceed to S55.

In S55, the processor 22 compares a value of the “current number of times of updating” item of the management table 50 with a value of the “set number of times of updating” item of the management table 50. If the value of the “current number of times of updating” item of the management table 50 is larger than the value of the “set number of times of updating” item of the management table 50, the processor 22 causes the irregular backup process to proceed to S58. If the value of the “current number of times of updating” item of the management table 50 is not larger than the value of the “set number of times of updating” item of the management table 50, the processor 22 terminates the irregular backup process.

In S56, the processor 22 compares the value of the “current holding time period” item of the management table 50 with the value of the “set holding time period” item of the management table 50. If the value of the “current holding time period” item of the management table 50 is larger than the value of the “set holding time period” item of the management table 50, the processor 22 causes the irregular backup process to proceed to S57. If the value of the “current holding time period” item of the management table 50 is not larger than the value of the “set holding time period” item of the management table 50, the processor 22 terminates the irregular backup process.

In S57, the processor 22 compares the value of the “current number of times of updating” item of the management table 50 with the value of the “set number of times of updating” item of the management table 50. If the value of the “current number of times of updating” item of the management table 50 is larger than the value of the “set number of times of updating” item of the management table 50, the processor 22 causes the irregular backup process to proceed to S58. If the value of the “current number of times of updating” item of the management table 50 is not larger than the value of the “set number of times of updating” item of the management table 50, the processor 22 terminates the irregular backup process.

In S58, the processor 22 backs up the data (of the updated file) cached in the SSD 213 into an HDD 212.

In S59, the processor 22 compares a value of the “current number of generations” item of the management table 50 with a value of the “requisite number of generations” item of the management table 50. If the value of the “current number of generations” item of the management table 50 is equal to the value of the “requisite number of generations” item of the management table 50, the processor 22 causes the irregular backup process to proceed to S60. If the value of the “current number of generations” item of the management table 50 is not equal to the value of the “requisite number of generations” item of the management table 50, the processor 22 causes the irregular backup process to proceed to S61.

In S60, the processor 22 deletes, from the HDD 212, backup data of the oldest generation among backup data of the updated file. After S60, the processor 22 terminates the irregular backup process.

In S61, the processor 22 updates the “current number of generations” item of the management table 50 (for example, increments the value of the “current number of generations” item by 1). After S61, the processor 22 terminates the irregular backup process.

According to the irregular backup process, the NAS device 20 may back up data to be updated for a short time period, among data cached in the SSDs 213, into the HDDs 212.

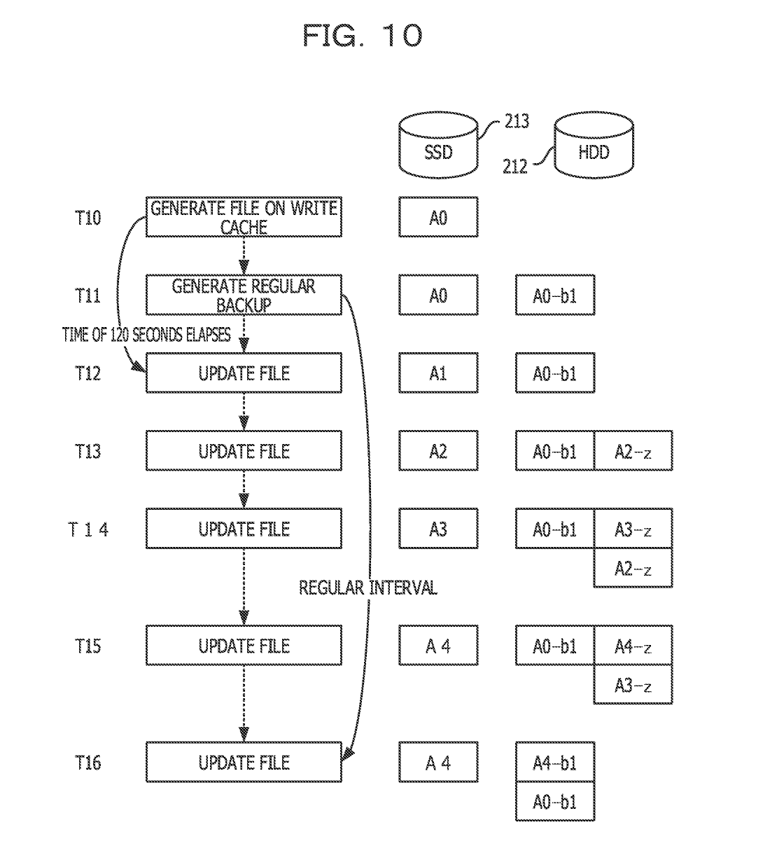

Next, an example of the irregular backup process is described with reference to FIG. 10. FIG. 10 is a diagram illustrating an example of regular backup and irregular backup according to the second embodiment. Files in FIG. 10 have different file names A0, A1, A2, A3, and A4 in order to easily distinguish the generations from each other, but are files with the same UNIX inode number. When the generations are not distinguished from each other, each of the files is referred to as a file A.

At a time T10, the NAS device 20 receives the file A0 from a client terminal 11 through an external interface unit 27 and writes the received file A0 in the RAM 23 through the bus 28. If an SSD 213 has an available region as a write cache, the NAS device 20 generates the file A0 in the SSD 213. In addition, the NAS device 20 generates a management table for the file A. After the generation of the file A0 in the SSD 213, the NAS device 20 notifies the client terminal 11 of completion of the writing. In this manner, the SSD 213 stores the file A0. The HDD 212 has yet to back up the file A0 since the time T10 is before the next regular backup.

It is assumed that in the management table for the file A, “1” (representing that backup is to be performed) is set in the “backup determination” item, “1” (representing that a set number of times of updating is 1) is set in the “set number of times of updating” item, and “120” (representing 120 seconds) is set in the “set holding time period” item. In addition, it is assumed that in the management table for the file A, “1” (representing a file) is set in the “backup target” item and “2” (representing two generations) is set in the “requisite number of generations” item. Furthermore, it is assumed that in the management table for the file A, “1” (representing an HDD 212) is set in the “backup destination” item and “2” (representing the logical product) is set in the “backup acquisition requirement” item.

At a time T11, the NAS device 20 acquires, in accordance with an instruction received from the client terminal 11 or internal settings, a backup (regular backup) of a file stored in a storage region managed by the NAS device 20. At the time T11, the NAS device 20 generates a file A0-b1 as a regular backup of the file A0 existing on the write cache and causes the file A0-b1 to be stored in the HDD 212.

A time T12 is when a time of 120 seconds or more elapses after the time T10. Thus, a time period during which the file A0 is held by the write cache exceeds the set holding time period of “120 seconds”.

The NAS device 20 receives the file A1 (obtained by updating the file A0) from the client terminal 11 through the external interface unit 27 and writes the received file A1 in the RAM 23 through the bus 28. If the SSD 213 has an available region as a write cache, the NAS device 20 updates the file A0 stored in the SSD 213 to the file A1. The NAS device 20 updates the management table for the file A. After the generation of the file A1 in the SSD 213, the NAS device 20 notifies the client terminal 11 of completion of the writing. In this manner, the SSD 213 stores the file A1.

The NAS device 20 updates the management table by incrementing the value of the “current number of times of updating” item. Thus, the “current number of times of updating” item represents “1”. Since “1” represented by the “current number of times of updating” item is not larger than “1” represented by the “set number of times of updating” item, the requirement for the number of times of updating is not satisfied. Although the requirement for the holding time period is satisfied, the “backup acquisition requirement” item represents “2”. Thus, the requirement for starting backup is not satisfied. The HDD 212 holds the backup file A0-b1, but has yet to back up the file A1 since the time T12 is before the next regular backup.

At a time T13, the NAS device 20 updates the file A1 stored in the SSD 213 to the file A2 in the same manner as the update of the file at the time T12. The NAS device 20 updates the management table for the file A by incrementing the value of the “current number of times of updating” item. Thus, the “current number of times of updating” item represents “2”. Since “2” represented by the “current number of times of updating” item is larger than “1” represented by the “set number of times of updating” item, the requirement for the number of times of updating is satisfied. The requirement for the holding time period is satisfied and the “backup acquisition requirement” item represents “2”. Thus, the requirement for starting backup is satisfied. The HDD 212, therefore, holds the regular backup file A0-b1 and an irregular backup file A2-z obtained by backing up the file A2. The NAS device 20 updates the management table for the file A by incrementing the value of the “current number of generations”.

In this manner, the NAS device 20 may set the requirement for starting backing up the file A based on a usage state of the file, a user's demand, or a demand by an application process. Thus, the NAS device 20 may suppress an excessive amount of backup files and an excessive number of processes of managing files while backing up files.

At a time T14, the NAS device 20 updates the file A2 stored in the SSD 213 to the file A3 in the same manner as the update of the file at the time T12. The NAS device 20 updates the management table for the file A by incrementing the value of the “current number of times of updating” item. Thus, the “current number of times of updating” item represents “3”. Since “3” represented by the “current number of times of updating” item is larger than “1” represented by the “set number of times of updating” item, the requirement for the number of times of updating is satisfied. The requirement for the holding time period is satisfied and the “backup acquisition requirement” item represents “2”. Thus, the requirement for starting backup is satisfied. The HDD 212, therefore, holds the regular backup file A0-b1, the irregular backup file A2-z, and an irregular backup file A3-z obtained by backing up the file A3. The NAS device 20 updates the management table for the file A by incrementing the value of the “current number of generations” item.

At a time T15, the NAS device 20 updates the file A3 stored in the SSD 213 to the file A4 in the same manner as the update of the file at the time T12. The NAS device 20 updates the management table for the file A by incrementing the value of the “current number of times of updating” item. Thus, the “current number of times of updating” item represents “4”. Since “4” represented by the “current number of times of updating” item is larger than “1” represented by the “set number of times of updating” item, the requirement for the number of times of updating is satisfied. The requirement for the holding time period is satisfied and the “backup acquisition requirement” item represents “2”. Thus, the requirement for starting backup is satisfied. The HDD 212, therefore, holds the regular backup file A0-b1, the irregular backup file A3-z, and an irregular backup file A4-z obtained by backing up the file A4. The NAS device 20 updates the management table for the file A4 by incrementing the value of the “current number of generations” item.

In this case, since the “requisite number of generations” item for the file A represents “2”, the NAS device 20 deletes the irregular backup file A2-z.

In this manner, the NAS device 20 may set a requisite number of generations of the file A to be backed up based on a usage state of the file, a user's demand, or a demand by an application process. Thus, the NAS device 20 may suppress an excessive amount of backup files and an excessive number of processes of managing files while backing up files.

At a time T16, the NAS device 20 generates a backup file A4-b1 as a regular backup of the file A4 stored on the write cache in the same manner as the generation of the backup at the time T11. Although the NAS device 20 adds the regular backup file, the NAS device 20 may generate the backup file by updating a past backup file.

Thus, the NAS device 20 holds the regular backup file A0-b1 and a regular backup file A4-b1 obtained by backing up the file A4. The NAS device 20 deletes the irregular backup files A3-z and A4-z due to the regular backup of the file A4.

Since the NAS device 20 deletes an irregular backup file when performing the regular backup, the NAS device 20 may suppress an excessive amount of backup files and an excessive number of processes of managing files while backing up files. Deletion of an irregular backup file when the next regular backup is performed is an example of a requirement for deleting an irregular backup file. The irregular backup file may be deleted when the regular backup after the next regular backup is performed or when the target file is purged from the write cache.

In addition, the NAS device 20 may select a file to be updated at a high rate from among data existing on the write cache and generate an irregular backup of the selected file. Thus, the NAS device 20 may suppress wasteful backups of data, such as a wasteful backup of a file that is not updated.

The NAS device 20 may back up data to be updated at short intervals without reducing intervals between times when the regular backup is performed. Thus, the NAS device 20 may suppress an excessive amount of backup files and an excessive number of processes of managing files while backing up files.

The NAS device 20 according to the second embodiment generates a backup file every time a file is updated after satisfaction of the requirement for starting backup. The NAS device 20 according to the second embodiment may generate a backup file every time a file for which a predetermined requirement is satisfied is updated. For example, the NAS device 20 may generate a backup file when a file is updated predetermined times (for example, 10 times). Alternatively, the NAS device 20 may generate a backup file when a file is updated by a predetermined user.

The aforementioned processing functions may be achieved by a computer. In this case, a program in which the details of the processes of the functions of the NAS device 20 and the details of the processes of the functions of the storage device 1 described in the first embodiment are described is provided. The CPU of the computer executes the program to achieve the processing functions on the computer. The program in which the details of the processes are described may be stored in a computer-readable recording medium. The computer-readable recording medium is a magnetic storage device, an optical disc, a magneto-optical recording medium, a semiconductor memory, or the like. The magnetic storage device is a hard disk drive (HDD), a flexible disk (FD), a magnetic tape, or the like. The optical disc is a DVD, a DVD-RAM, a CD-ROM, a CD-RW, or the like. The magneto-optical recording medium is a magneto-optical (MO) disk or the like.

In order to distribute the program, a portable recording medium that has the program stored therein is sold. The portable recording medium is a DVD, a CD-ROM, or the like. The program may be stored in a storage device of a server computer and transferred from the server computer to another computer through a network.

The computer that is configured to execute the program stores, in a storage device of the computer, the program stored in the portable recording medium or transferred from the server computer, for example. The computer reads the program from the storage device of the computer and performs the processes in accordance with the program. The computer may read the program directly from the portable recording medium and perform the processes in accordance with the program. The computer may perform the processes in accordance with the program every time the computer receives the program transferred from the server computer connected to the computer through a network.

At least a part of the aforementioned processing functions may be achieved by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a first storage unit configured to temporarily store therein a file;
a second storage unit configured to store therein backup data of the file stored in the first storage unit; and
a processor configured to
manage
update states of files stored in the first storage unit and
a requirement to be satisfied for backing up the files stored in the first storage unit into the second storage unit, and
store, in the second storage unit, first backup data of a first file among the files stored in the first storage unit, an update state of the first file satisfying the requirement.

2. The storage device according to claim 1, wherein
the update states include a number of times of updating each file, and
the requirement is that the number of times is equal to or larger than a predetermined threshold.

3. The storage device according to claim 1, wherein
the update states include a time period during which each file is held by the first storage unit, and
the requirement is that the time period is equal to or longer than a predetermined threshold.

4. The storage device according to claim 1, wherein
the update states include
a number of times of updating each file and
a time period during which each file is held by the first storage unit, and
the requirement is
that the number of times is equal to or larger than a predetermined first threshold and
that the time period is equal to or longer than a predetermined second threshold.

5. The storage device according to claim 1, wherein
the processor is configured to
regularly store, in the second storage unit or a third storage unit, second backup data of the first file, and
delete the first backup data from the second storage unit upon storing the second backup data.

6. The storage device according to claim 1, wherein
the processor is configured to
delete, from the first storage unit, a file that is not updated for a predetermined time period.

7. A method for controlling a storage device, the method comprising:
managing, by a processor,
update states of files stored in a first storage unit and
a requirement to be satisfied for backing up the files stored in the first storage unit into a second storage unit; and
storing, in the second storage unit, first backup data of a first file among the files stored in the first storage unit, an update state of the first file satisfying the requirement.
